(19) United States
(12) Patent Application Publication
(10) Pub. No.: US 2024/0066773 A1
(43) Pub. Date: Feb. 29, 2024

(54) INJECTION MOLDING MACHINE, INJECTION MOLDING METHOD, AND INJECTION MOLD

(71) Applicant: KABUSHIKI KAISHA TOSHIBA, Tokyo (JP)

(72) Inventors: Yuko IIZUKA, Yokohama (JP); Satoshi SAYAMA, Yokohama (JP)

(73) Assignee: KABUSHIKI KAISHA TOSHIBA, Tokyo (JP)

(21) Appl. No.: 18/348,412

(22) Filed: Jul. 7, 2023

(30) Foreign Application Priority Data
Aug. 24, 2022 (JP) 2022-133621

(51) Int. Cl. B29C 45/27; B29C 45/73

(52) U.S. Cl. CPC B29C 45/2758; B29C 45/73

(57) ABSTRACT

An injection molding machine according to an embodiment includes an injection mechanism and an injection mold. The injection mechanism injects resin. The injection mold includes a fixed part and a movable part. The fixed part includes a resin injection port through which resin injected by the injection mechanism enters. The movable part serves to mold the entered resin. The resin fills a cavity between the fixed part and the movable part. The injection mold includes a sprue, a back-flow prevention mechanism, and a heater. The sprue is provided in the fixed part. The sprue allows resin to enter the cavity through the sprue. The sprue has a taper shape tapered off toward the resin injection port. The back-flow prevention mechanism serves to block resin flowing back through the sprue from the cavity toward the resin injection port. The heater serves to keep resin in a molten state.

### CROSS-REFERENCE TO RELATED APPLICATIONS

This application is based upon and claims the benefit of priority from Japanese Patent Application No. 2022-133621, filed on Aug. 24, 2022; the entire contents of which are incorporated herein by reference.

### FIELD

Embodiments described herein relate generally to an injection molding machine.

### BACKGROUND

An injection molding machine has been known, which performs molding by injecting molten resin into an injection mold. In the injection molding machine, there is a filling process in which molten resin injected from an injection mechanism is filled into a cavity of the injection mold. After that, molten resin filled into the cavity is solidified and thereby a resin molded item is produced.

A compression process is sometimes performed in the injection molding. In the compression process, a mold clamping mechanism applies pressure to the injection mold after molten resin is filled into the cavity.

To enhance the quality of a resin molded item, holding of pressure to be applied by the injection mechanism to the injection mold in the filling process is set, and pressure is applied to molten resin in the cavity from the outside in the compression process of controlling a mold clamping amount and a mold clamping force.

The molten resin filled into the cavity in above-described processes has high internal pressure. Therefore, when pressure applied from the outside is stopped before a path of molten resin is solidified, molten resin in the cavity flows backward to the injection mechanism side. This phenomenon causes deterioration in quality of resin molded items. Therefore, an injection molding machine that can prevent back-flow of molten resin has been needed.

### BRIEF DESCRIPTION OF THE DRAWINGS

FIG. 1 is a side view schematically illustrating an injection molding device according to a first embodiment;

FIG. 2 is a cross-sectional diagram illustrating a configuration of an injection mold according to the first embodiment;

FIGS. 3A to 3C are schematic cross-sectional diagrams of an installation location of a heater according to the first embodiment that is viewed from a first direction D1;

FIG. 4 is a cross-sectional diagram illustrating an example of a back-flow prevention mechanism of the injection mold according to the first embodiment;

FIGS. 5A and 5B are schematic diagrams illustrating a method of inserting a divider plate having openings into the middle of a resin flow path according to the first embodiment;

FIGS. 6A to 6F are cross-sectional diagrams of a divider plate included in a back-flow prevention mechanism according to the first embodiment;

FIG. 7 is a cross-sectional diagram schematically illustrating another example of a back-flow prevention mechanism of the injection mold according to the first embodiment; and

FIG. 8 is a cross-sectional diagram illustrating a structure of an injection mold according to a second embodiment.

### DETAILED DESCRIPTION

An injection molding machine according to an embodiment includes an injection mechanism and an injection mold. The injection mechanism injects resin. The injection mold includes a fixed part and a movable part. The fixed part includes a resin injection port through which resin injected by the injection mechanism enters. The movable part serves to mold the entered resin. The resin injected by the injection mechanism enters a cavity between the fixed part and the movable part through a sprue, a runner, and a gate to fill the cavity.

The sprue is provided in the fixed part of the injection mold. The sprue has a taper shape tapered toward the resin injection port, and allows resin to enter the cavity through the sprue. The injection mold further includes a back-flow prevention mechanism and a heater. The back-flow prevention mechanism is inserted in the middle of the sprue. The heater is provided in an outer peripheral portion of the sprue to keep resin in a molten state.

Hereinafter, an injection molding machine of an embodiment will be described with reference to the drawings. Note that, in this specification, a vertically-upward direction and a vertically-downward direction are basically defined as an upward direction and a downward direction, respectively.

### First Embodiment

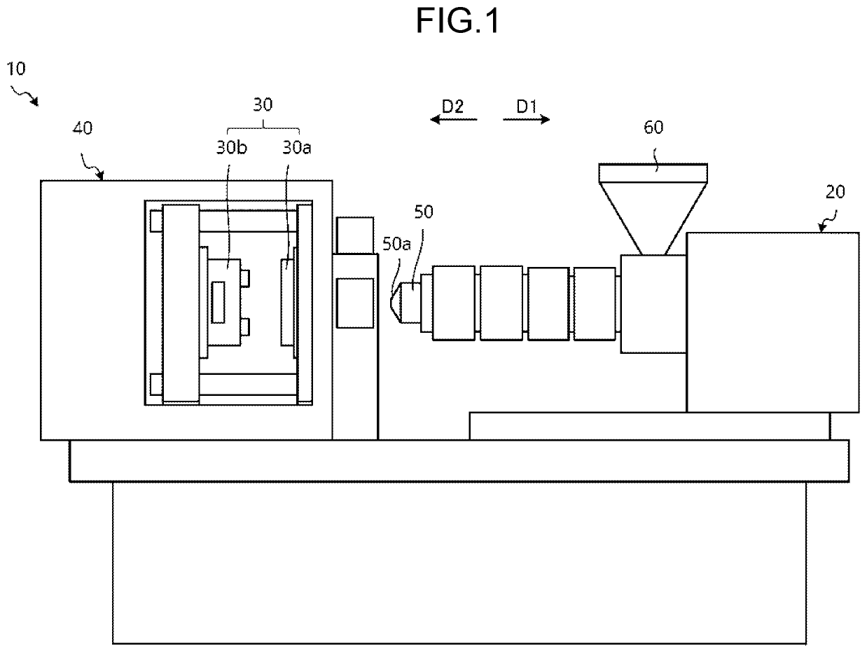

An injection molding machine of the first embodiment will be described with reference to FIGS. 1 to 7. FIG. 1 is a side view schematically illustrating an injection molding device according to the first embodiment. An injection molding machine 10 performs molding by injecting molten resin into an injection mold 30 from an injection mechanism 20.

As illustrated in FIG. 1, the injection molding machine 10 includes the injection mechanism 20 for injecting molten resin, the injection mold 30 that molds the injected molten resin, and a mold clamping mechanism 40 that performs opening/closing operation of an injection mold. The injection mold 30 includes a fixed part 30a and a movable part 30b. In FIG. 1, a first direction D1 corresponds to a direction in which the movable part 30b is moved to approach the fixed part 30a. A second direction D2 is opposite to the first direction D1, and corresponds to a direction in which the movable part 30b is moved to leave the fixed part 30a.

Note that the injection molding machine 10 may include other components such as a control device, etc.

The injection mechanism 20 included in the injection molding machine 10 according to the present embodiment will be described. The injection mechanism 20 includes a cylinder 50 and a hopper 60. While melting pellets of resin materials stored in the hopper 60 by heat of a heater (not illustrated) in the cylinder 50, the injection mechanism 20 feeds molten resin to the leading end side of the cylinder 50 by utilizing the revolution of a screw, and stores the molten resin in there. By pushing out the screw, the injection mechanism 20 injects molten resin into the injection mold 30 from a nozzle 50a positioned at the leading end of the cylinder 50.

Material to be injected from the injection mechanism 20 includes general thermoplastic resin. Note that filler may be added.

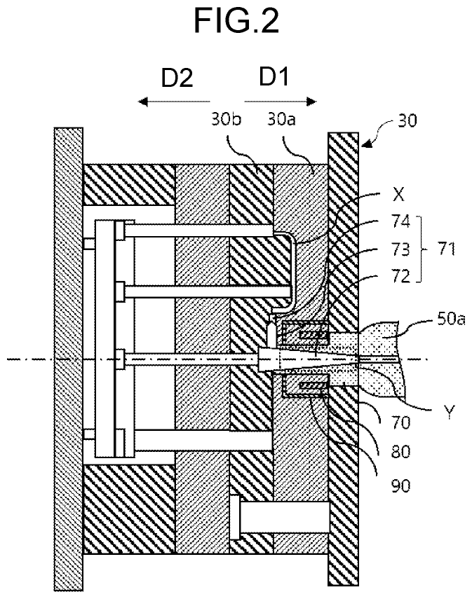

Next, the injection mold 30 included in the injection molding machine 10 according to the present embodiment will be described. FIG. 2 is a cross-sectional diagram illustrating a configuration of an injection mold according to the first embodiment. As illustrated in FIG. 2, the injection mold 30 includes a sprue bush 70, a resin flow path 71, the fixed part 30a, the movable part 30b, and a heater 80. A cavity X is formed as a space between the fixed part 30a and the movable part 30b.

The sprue bush 70 is attached to the fixed part 30a. The sprue bush 70 forms a sprue 72 and gets into contact with the nozzle 50a when resin is injected. Molten resin injected from the nozzle 50a flows in the order of the leading end of the sprue bush 70, the sprue 72, a runner 73, and a gate 74, and then enters the cavity X.

The resin flow path 71 includes the sprue 72, the runner 73, and the gate 74.

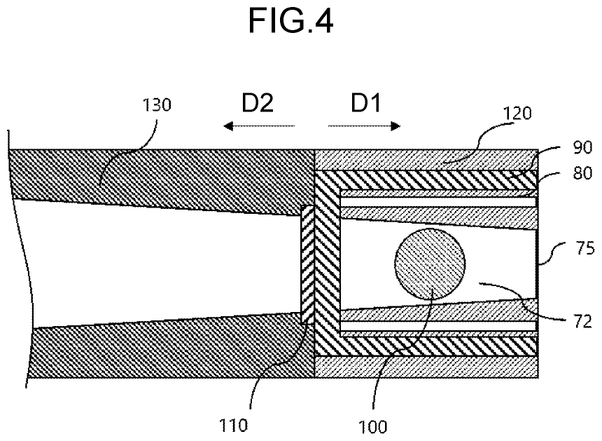

An inner shape of the sprue 72 is a taper shape that is tapered off in the first direction D1. In other words, the sprue 72 is tapered off toward a resin injection port 75 (FIG. 4) described later.

The movable part 30b can move in the first direction D1 and the second direction D2 with respect to the fixed part 30a. The second direction D2 is an opposite direction of the first direction D1. When the injection mold 30 is opened, the movable part 30b is separated from the fixed part 30a in the second direction D2. When the injection mold 30 is closed, the movable part 30b moves in the first direction D1, and the cavity X being a closed space is formed between the fixed part 30a and the movable part 30b.

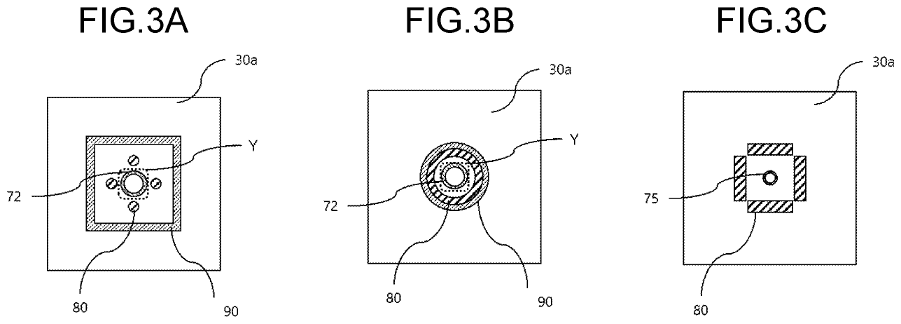

The heater 80 is a device serving to keep a molten state of resin injected into a back-flow prevention mechanism unit Y installed in the sprue 72. The back-flow prevention mechanism unit Y is part of an internal space of the sprue 72. The back-flow prevention mechanism unit Y can be provided with a back-flow prevention mechanism described later. FIGS. 3A to 3C are schematic cross-sectional diagrams of an installation location of a heater according to the first embodiment that is viewed from the first direction D1. As illustrated in FIGS. 3A to 3C, the heater 80 is basically arranged along the outer periphery of the back-flow prevention mechanism unit Y. For example, as illustrated in FIG. 3A viewed in the first direction D1, rod-shaped heaters 80 extending in the second direction D2 from a resin inflow port can be provided around the back-flow prevention mechanism unit Y. Moreover, as illustrated in FIG. 3B, a circular (or cylindrical) heater 80 can be installed in a manner of surrounding the periphery of the back-flow prevention mechanism unit Y, or as illustrated in FIG. 3C, heaters 80 can be arranged near the resin injection port 75. In addition, in each case, a heat insulating material 90 can also be provided in a manner of surrounding the heater 80 and the back-flow prevention mechanism unit Y, but the heat insulating material 90 is not indispensable. FIGS. 3A to 3C each illustrate an example of an installation location of the heater(s) 80, and the installation location is not limited to these. For example, the heater(s) may be installed at a location separated from the back-flow prevention mechanism unit Y, and a heat-transfer member that transfers the heat of the heater may be provided in an outer peripheral portion of the back-flow prevention mechanism unit Y.

Next, a back-flow prevention mechanism of molten resin according to the present embodiment, which is provided in the sprue 72 between the injection mechanism 20 and the cavity X of the injection mold 30, will be described.

As described above, the back-flow prevention mechanism is a mechanism for preventing molten resin, to which pressure has been applied, from flowing backward from the cavity X toward the resin injection port 75 and the injection mechanism 20 in a case where pressure application from the outside is stopped before resin in the resin flow path 71 is solidified. In the present embodiment, the back-flow prevention mechanism of molten resin provided in the sprue 72 will be described.

FIG. 4 is a cross-sectional diagram illustrating an example of the back-flow prevention mechanism of the injection mold according to the first embodiment. As illustrated in FIG. 4, the back-flow prevention mechanism is incorporated as part of the sprue 72. The sprue 72 is provided with the back-flow prevention mechanism including a valve element 100 and a divider plate 110 with openings. The sprue 72 includes a first cylindrical member 120 and a second cylindrical member 130. The sprue 72 can be assembled by fitting the first cylindrical member 120 and the second cylindrical member 130 with one another. Note that, as described above, the heater 80 for keeping the molten state of resin is installed in the outer peripheral portion of the back-flow prevention mechanism unit Y, which is located between the resin injection port 75 and the divider plate 110. The heat insulating material 90 may also be provided in the outer peripheral portion of the heater 80, as illustrated in FIG. 4.

The divider plate 110 is inserted in the middle of the sprue 72 so as to partly block up the sprue 72. Specifically, for example, the divider plate 110 is provided in a section at 10 mm to 30 mm from the resin injection port 75. Note that an installation position of the divider plate 110 is not limited to this example. The divider plate 110 is preferably positioned within a range in the sprue 72 where resin is melt by the heater 80.

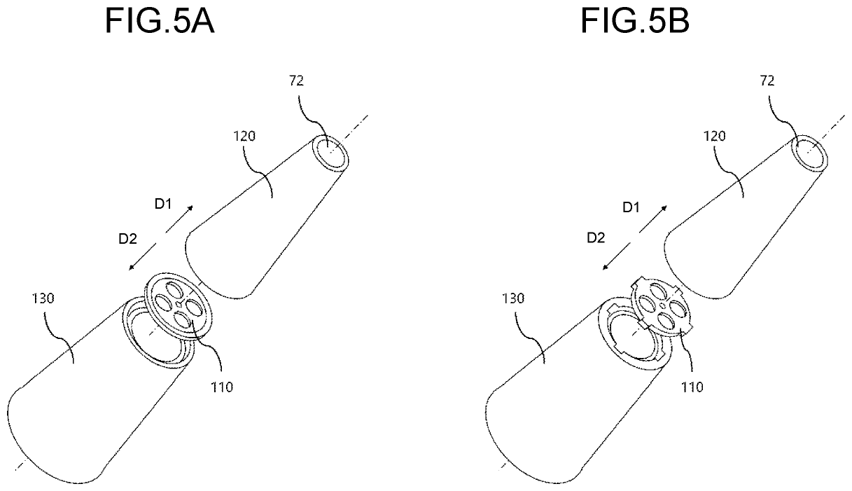

Subsequently, a method of fixing the divider plate 110 will be described with making reference to FIGS. 5A and 5B. FIGS. 5A and 5B are schematic diagrams illustrating a method of inserting a divider plate having openings into the middle of the sprue 72 as a resin flow path according to the first embodiment. The sprue 72 includes the first cylindrical member 120 and the second cylindrical member 130. For example, as illustrated in FIG. 5A, the divider plate 110 is inserted between the first cylindrical member 120 and the second cylindrical member 130. The second cylindrical member 130 is provided with a recess part. The divider plate 110 is fitted into the recess part of the second cylindrical member 130. Alternatively, as illustrated in FIG. 5B, one or more convex parts are provided in the outer circumferential portion of the divider plate 110, and one or more concave parts corresponding to the convex parts of the divider plate 110 are provided in an opening edge of the second cylindrical member 130. The convex parts of the divider plate 110 are fitted into the concave parts of the second cylindrical member 130, and thereby the divider plate 110 is inserted between the first cylindrical member 120 and the second cylindrical member 130. The valve element 100 is provided between the divider plate 110 and the resin injection port 75 of the sprue 72.

The valve element 100 has a spherical shape, for example. Not limited to the spherical shape, the valve element 100 is only required to have a shape that can move inside the sprue 72 and can block up the resin injection port 75. In view of smoothness of movement, the shape of the valve element 100 is preferably a spherical shape described above. A diameter of the valve element 100 is larger than a diameter of the resin injection port 75 of the sprue 72, and is larger than the dimension of each opening (115) formed in the divider plate 110. In addition, the diameter of the valve element 100 is smaller than an outer diameter of the divider plate 110.

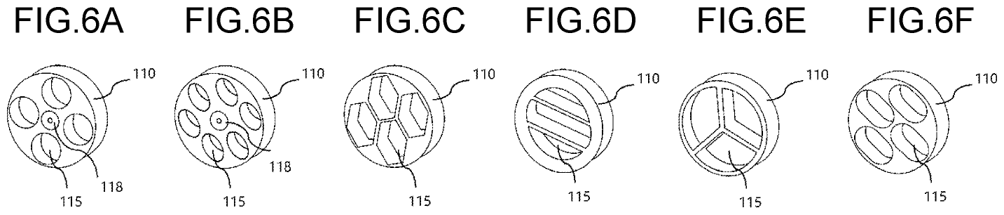

FIGS. 6A to 6F illustrate cross-sectional diagrams of the divider plate 110 included in the back-flow prevention mechanism according to the first embodiment. An exterior shape of the divider plate 110 is similar to the cross-section of the sprue 72. The divider plate 110 has an approximately-circular shape, for example. The divider plate 110 includes the openings 115, and may also include a depression 118. Nevertheless, each shape of the divider plates 110 illustrated in FIGS. 6A to 6F is an example, and is not limited to those shapes. The divider plate 110 is provided with a plurality of openings 115. As illustrated in FIGS. 6A to 6F, the shape of the openings 115 can be any shape such as a circle, an ellipse, a polygon, a slit shape, a sector, or an amorphous shape. In consideration of resistance to accumulation of impurities contained in molten resin, the shape of each opening 115 is desirably a circular shape or an elliptical shape, which has no corner. Moreover, in consideration of workability of the divider plate 110, the shape of the openings 115 is more preferably a circular shape. In addition, the dimensions of all the openings 115 may be the same dimension, or may be different dimensions, but in consideration of well-balanced flow of molten resin, the dimensions of the openings 115 are desirably almost the same dimension. As the arrangement of the openings 115, the openings 115 are preferably arranged point-symmetrically or line-symmetrically, but the openings 115 may be arranged at asymmetric positions. In addition, the openings 115 are more desirably arranged at regular intervals because molten resin flows in a unified direction smoothly. Moreover, the depression 118 being a recess portion functioning as a tray of the valve element 100 can be provided near a centroid portion of the divider plate 110, but the depression 118 needs not be always provided.

The dimension of each opening 115 will be described. The dimension of the opening 115 is defined by any of a side, a longest diagonal line, a diameter, a radius, and a minor axis of the opening. For example, in a case where the opening 115 is a circle, a diameter is measured, in a case where the opening 115 is an ellipse, a minor axis is measured. In a case where the opening 115 is a triangle, a diameter of an inscribed circle of the triangle is measured. In a case where the opening 115 is a quadrangle, the length of a short side is measured. In a case where the opening 115 is a polygon, a longest diagonal line is measured. In a case where the opening 115 is a slit, the length in a short side direction of a portion with the largest area of the provided slit is measured. In a case where the opening 115 is a sector, a radius is measured. In any case, the openings 115 of the divider plate each have a size that does not allow the valve element 100 to pass through each opening 115.

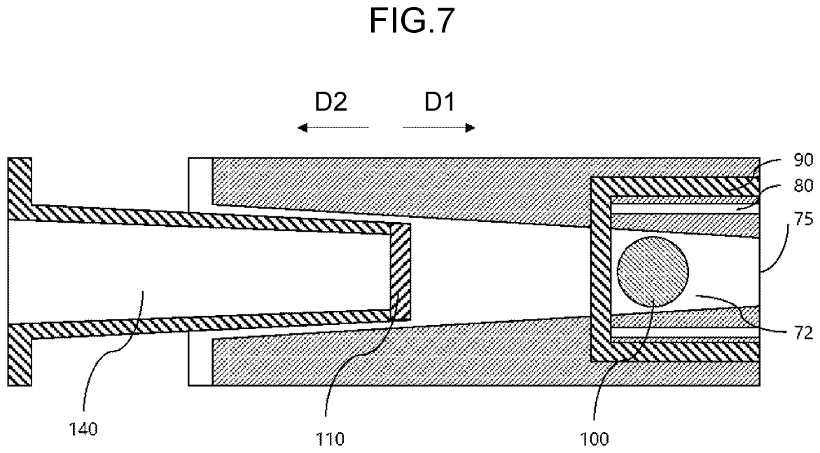

A modified example of an installation method of the divider plate 110 will be described. FIG. 7 is a cross-sectional diagram schematically illustrating another example of a back-flow prevention mechanism of the injection mold according to the first embodiment. A sprue 72 includes an internal cylinder 140 and a valve element 100. The internal cylinder 140 includes a divider plate 110 with a plurality of openings. The divider plate 110 is provided at the leading end portion on the resin injection port 75 side. The outer shape of the internal cylinder 140 is a taper shape being tapered off in the direction toward the divider plate 110 and corresponding to the inner shape of the sprue 72. The internal cylinder 140 is fitted into the sprue 72. In the present embodiment, the internal cylinder 140 can be inserted into the sprue 72 in the first direction D1, and can be removed from the sprue 72 in the second direction D2. The length of the internal cylinder 140 is shorter than the sprue 72. The valve element 100 is provided at, for example, a position closer to the resin injection port 75 than the divider plate 110 of the internal cylinder 140 inserted halfway in the sprue 72.

Subsequently, operation of the back-flow prevention mechanism will be described. First of all, while resin is being injected from the nozzle 50a, the valve element 100 moves in the second direction D2 being the same direction as injected resin, and stays on the divider plate 110. At this time, if the depression 118 is provided on the divider plate 110, the valve element 100 can be guided to a desired position on the divider plate 110. In consideration of a movement flow of resin, the valve element 100 preferably stays near the center of the divider plate 110. Thus, the depression 118 is desirably provided near the center of the divider plate 110. The resin passes through the openings 115 provided in the divider plate 110 and then enters the cavity X.

After injection end or when operation of the injection mechanism 20 is stopped, when the nozzle 50a of the cylinder 50 is separated from the sprue bush 70, or when pressure from the injection mechanism 20 side applied to the sprue bush 70 decreases, the valve element 100 moves in the first direction D1 due to a pressure difference between pressure in the cavity X and the outside of the injection mold 30. The valve element 100 is larger in size than the resin injection port 75. Thus, the valve element 100 moves up to the vicinity of the resin injection port 75 and stays there. The valve element 100 is configured to block up the resin injection port 75, in other words, configured to isolate the inside of the sprue 72 from the outside of the sprue 72. This can prevent molten resin from leaking to the outside.

With the configuration described above, it is possible to produce a high-quality resin molded item with no sink.

In the injection molding machine 10 according to the present embodiment, it is possible to prevent resin filled into the cavity X, from running back inside the sprue 72 and flowing backward to the outside of the sprue 72. By providing the valve element 100 in the middle of the sprue 72, it becomes unnecessary to keep pressure from the injection mechanism 20 side during solidification of resin. Thus, it is possible to reduce load of a motor of the injection mechanism 20.

In addition, the inner shape of the sprue 72 of the back-flow prevention mechanism, through which resin passes, is a taper shape and is flat and smooth. Therefore, when injected resin flows out of the sprue 72, pressure applied inside the sprue 72 is not concentrated on a specific point but distributed. Since the pressure is distributed, the injection mold 30 can be made indestructible, and maintenance frequency can be reduced.

Moreover, the back-flow prevention mechanism included in the injection molding machine 10 according to the first embodiment has a simple structure, so that the manufacturing cost of the injection mold 30 can also be reduced.

Moreover, the shape of the sprue 72 of the back-flow prevention mechanism is a taper shape. Therefore, the mobility of the included valve element 100 becomes stable without providing a guide or the like in the middle of the sprue 72.

### Second Embodiment

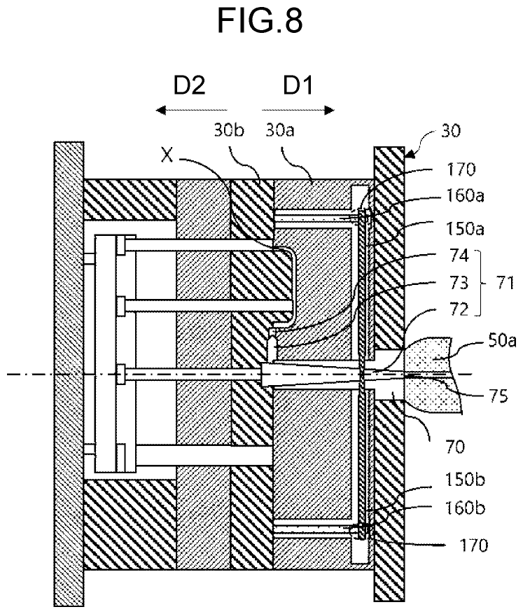

Next, an injection molding machine 10 according to the second embodiment will be described with reference to FIG. 8. The second embodiment differs from the first embodiment in the structure of a back-flow prevention mechanism. The second embodiment can be used for an injection compression molding method. The structure of the injection mechanism 20 is the same as that in the first embodiment. The above-mentioned different point will be specifically described.

FIG. 8 is a cross-sectional diagram illustrating a structure of an injection mold according to the second embodiment. As illustrated in FIG. 8, an injection mold 30 includes a back-flow prevention mechanism, a sprue bush 70, a resin flow path 71, a fixed part 30a, a movable part 30b, and a heater (not illustrated). The back-flow prevention mechanism includes a pin 160a, a pin 160b, link mechanisms 170 each being a transmission mechanism, a shield 150a, and a shield 150b.

An inner shape of the sprue 72 is a taper shape tapered off in the first direction D1. Therefore, when resin filled into the cavity X flow back toward the resin injection port 75 (that is, flow back in the first direction D1), there is no specific point on which stress concentrates. Therefore, the injection mold 30 becomes indestructible.

The back-flow prevention mechanism is incorporated into the fixed part 30a. In the fixed part 30a, the pin 160a is provided in an upper portion of the sprue 72, and the pin 160b is provided in a lower portion of the sprue 72.

Each of the link mechanisms 170 is configured to convert a movement in a horizontal direction into a movement in a vertical direction. Specifically, the link mechanisms 170 are provided at leading end portions in the first direction D1 of the pin 160a and the pin 160b to transmit the movements in the first direction D1 of the pin 160a and the pin 160b to the shield 150a and the shield 150b.

The shield 150a and the shield 150b are incorporated into the fixed part 30a at orientation approximately vertical to the pins. For example, in FIG. 8, the shield 150a and the shield 150b are installed near the sprue bush 70 in a manner of passing through inside of the sprue bush 70. Note that installation locations of the shield 150a and the shield 150b are not limited to this example. The shield 150a and the shield 150b can be provided in an upper portion and a lower portion in a sprue portion of the sprue bush 70 where resin is in the molten state. The sprue portion of the sprue bush 70 is provided with holes into which the shields 150a and 150b can be inserted. When the movement in the first direction D1 of the pin 160a is transmitted from the link mechanism 170, the shield 150a moves downward, and part of the shield 150a reaches the inside of the sprue portion. Additionally, when the movement in the first direction D1 of the pin 160b is transmitted from the link mechanism 170, the shield 150b moves upward, and part of the shield 150b reaches the inside of the sprue portion.

When the shield 150a and the shield 150b get into contact with one another inside the sprue portion, a flow of resin can be blocked.

Each shape of the shield 150a and the shield 150b can be a rectangle or can be a taper shape that is entirely or partly tapered off in the direction toward the sprue portion. By forming the shield 150a and the shield 150b into such a taper shape, resin flowing back in the sprue 72 can be smoothly cut off.

Subsequently, operation of the back-flow prevention mechanism according to the second embodiment will be described. First of all, while resin is being injected from the nozzle 50a, the resin is filled into the cavity X through the sprue 72, a runner 73, and a gate 74. After injection end, by moving the movable part 30b in the first direction D1, the movable part 30b pushes in the pin 160a and the pin 160b in the first direction D1. The horizontal movements of the pins 160a and 160b are converted by the link mechanism 170 into the vertical movements of the shield 150a and the shield 150b. The correspondence between a push amount of the pin 160a and the pin 160b and a movement amount of the shields 150a and 150b can be adjusted by the link mechanism 170. With the adjustment, the shield 150a and the shield 150b move until the leading end of the shield 150a and the leading end of the shield 150b get into contact with one another. Then, by the shield 150a and the shield 150b getting into contact with each other, the cross-section of the sprue 72 can be blocked up. This prevents molten resin from leaking to the outside.

According to the back-flow prevention mechanism according to the second embodiment, a mechanism or a device that disturbs the flow of resin is not installed in the middle of the resin flow path 71. Therefore, resin inflow at the time of resin injection can be efficiently performed.

In particular, when injection molding of highly-viscous resin is performed in a molten state, resin molding can be efficiently performed.

In addition, in the first embodiment, when impurity or carbonized resin, etc. flow in, those solids are considered to block up part of the openings 115 provided in the divider plate 110. In this case, a work of removing solids blocking the openings 115 is sometime required, and the manufacturing of resin molded items might be interrupted. On the other hand, in a case where the sprue 72 is blocked up with a blocking plate as in the second embodiment, even when impurities are contained in resin, the resin can enter the cavity X without stopping flow of the resin. Therefore, it becomes possible to continue to produce resin molded items without interrupting the production line of resin molded items.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An injection molding machine comprising:
an injection mechanism configured to inject resin; and
an injection mold including a fixed part and a movable part, the fixed part including a resin injection port through which resin injected by the injection mechanism enters, the movable part being configured to mold the entered resin, the resin filling a cavity between the fixed part and the movable part,
wherein the injection mold includes:
a sprue provided in the fixed part and configured to allow resin to enter the cavity through the sprue, the sprue having a taper shape tapered off toward the resin injection port;
a back-flow prevention mechanism configured to block resin flowing back through the sprue from the cavity toward the resin injection port; and
a heater configured to keep resin in a molten state.

2. The injection molding machine according to claim 1, wherein the heater is provided to extend in a longitudinal direction of the sprue.

3. The injection molding machine according to claim 1, wherein the heater is disposed to surround an outer peripheral portion of the sprue.

4. The injection molding machine according to claim 1, wherein the back-flow prevention mechanism includes:
a divider plate inserted in the middle of the sprue, the divider plate including openings; and
a valve element provided inside the sprue and provided between the divider plate and the resin injection port, the valve element being larger than a diameter of the resin injection port and larger than each of the openings of the divider plate.

5. The injection molding machine according to claim 2, wherein the back-flow prevention mechanism includes:
a divider plate inserted in the sprue, the divider plate including openings; and
a valve element provided inside the sprue and provided between the divider plate and the resin injection port, the valve element being larger than a diameter of the resin injection port and larger than a dimension of each of the openings of the divider plate.

6. The injection molding machine according to claim 3, wherein the back-flow prevention mechanism includes:
a divider plate inserted in the sprue, the divider plate including openings; and
a valve element provided inside the sprue and provided between the divider plate and the resin injection port, the valve element being larger than a diameter of the resin injection port and larger than a dimension of each of the openings of the divider plate.

7. The injection molding machine according to claim 4, wherein each of the openings of the divider plate has a circular shape.

8. The injection molding machine according to claim 4, wherein the openings are arranged symmetrically in the divider plate.

9. The injection molding machine according to claim 4, wherein the openings are arranged at regular intervals in the divider plate.

10. The injection molding machine according to claim 1, wherein
the back-flow prevention mechanism includes:
a pin to be pushed by the movable part when the movable part moves toward the fixed part;
a blocking plate installed in an approximately vertical direction with respect to a movement direction of the movable part; and
a transmission mechanism configured to transmit, to the blocking plate, movement of the pin being pushed by the movable part, and
the blocking plate is configured to block up the sprue by the transmission mechanism when the movable part gets into contact with the fixed part.

11. The injection molding machine according to claim 2, wherein
the back-flow prevention mechanism includes:
a pin to be pushed by the movable part when the movable part moves toward the fixed part;
a blocking plate installed in an approximately vertical direction with respect to a movement direction of the movable part; and
a transmission mechanism configured to transmit, to the blocking plate, movement of the pin being pushed by the movable part, and
the blocking plate is configured to block up the sprue by the transmission mechanism when the movable part gets into contact with the fixed part.

12. The injection molding machine according to claim 3, wherein
the back-flow prevention mechanism includes:
a pin to be pushed by the movable part when the movable part moves toward the fixed part;
a blocking plate installed in an approximately vertical direction with respect to a movement direction of the movable part; and
a transmission mechanism configured to transmit, to the blocking plate, movement of the pin being pushed by the movable part, and
the blocking plate is configured to block up the sprue by the transmission mechanism when the movable part gets into contact with the fixed part.

13. The injection molding machine according to claim 10, wherein the blocking plate includes a leading end having a taper shape by which the sprue is blocked up.

14. An injection molding method comprising:
filling a cavity between a fixed part and a movable part with resin injected by an injection mechanism, the fixed part including a resin injection port through which resin injected by the injection mechanism enters, the movable part being configured to mold the entered resin;
performing processes in a state where the injection mechanism and the fixed part are in contact, the processes including
moving the movable part toward the fixed part,
pushing a pin by the movable part being moved,
transmitting, to a blocking plate, movement of the pin being pushed by the movable part, and
blocking up a sprue of the fixed part by the blocking plate; and
separating the injection mechanism from the fixed part.

15. An injection mold comprising:
a fixed part and a movable part, the fixed part including a resin injection port through which resin injected by an injection mechanism enters, the movable part being configured to mold the entered resin, the resin filling a cavity between the fixed part and the movable part,
a sprue provided in the fixed part and configured to allow resin to enter the cavity through the sprue, the sprue having a taper shape tapered off toward the resin injection port; and
a back-flow prevention mechanism configured to block resin flowing back through the sprue from the cavity toward the resin injection port.
